(19) United States
(12) Patent Application Publication
(10) Pub. No.: US 2014/0067903 A1
(43) Pub. Date: Mar. 6, 2014

(54) MEDIA QUERY ENGINE SYSTEM AND METHOD

(71) Applicants: JON ARNE SAETERAS, Sandnes (NO); Eivinn Hustveit, Sandnes (NO); Sverre Marvik, Ranheim (NO); Kjetil Oen, Saeboevaagen (NO); Anders Magnus Andersen, Sundbyberg (SE); Fredrik Harloff, Paradis (NO)

(72) Inventors: JON ARNE SAETERAS, Sandnes (NO); Eivinn Hustveit, Sandnes (NO); Sverre Marvik, Ranheim (NO); Kjetil Oen, Saeboevaagen (NO); Anders Magnus Andersen, Sundbyberg (SE); Fredrik Harloff, Paradis (NO)

(21) Appl. No.: 14/017,586

(22) Filed: Sep. 4, 2013

Related U.S. Application Data
(60) Provisional application No. 61/696,542, filed on Sep. 4, 2012.

(51) Int. Cl. H04L 29/08

(52) U.S. Cl. CPC H04L 67/02
USPC 709/201

(57) ABSTRACT

A method, computer program product, and computer system for receiving, at a first computing device from a second computing device, an HTTP request, including one or more request parameters, for a CSS file, wherein the CSS file requested includes at least one media query, and wherein the at least one media query includes at least one of a media-type and feature. One or more contextual properties associated with the second computing device are identified at the first computing device from the one or more request parameters. At least a portion of media query extensions associated with the at least one media query is executed at the first computing device based upon, at least in part, the one or more contextual properties, wherein at least the portion of the media query extensions is executed at the first computing device before a response to the HTTP request is sent to the second computing device. The response to the HTTP request is sent to the second computing device.

### RELATED CASES

This application claims the benefit of U.S. Provisional Application No. 61/696,542, filed on 4 Sep. 2012, by John Arne Saeteras, entitled “Media Query Engine System and Method”, the contents of which are all incorporated by reference.

### BACKGROUND

When adapting content to devices (e.g., mobile devices), device library data from a device description repository, such as Wireless Universal Resource File (WURFL), may be used as input. It's possible that one or more devices (e.g., user-agents), for example, browsers, may need special adaptation of a Cascading Style Sheet (CSS) to get a website working correctly. This may limit the design of websites as known bugs may have to be avoided on certain devices and/or browsers.

Additionally, even if standard CSS Media Queries offer sufficient functionality, such functionality may not be optimal, as the available media features that may be requested may be overly limited, and the User-Agent may not implement return the desired response. For example, “false positives” may result, where the User-Agent is claiming support for a specific media feature, but does not actually support it. Other examples may include the media=“screen” vs media=“handheld” issue, where mobile User-Agents may claim to be “screen” User-Agents, as browser vendors deemed it the best way to display a website on a mobile device.

### BRIEF SUMMARY OF DISCLOSURE

In one implementation, a method, performed by one or more computing devices, may comprise receiving, at a first computing device from a second computing device, an HTTP request, including one or more request parameters, for a CSS file, wherein the CSS file requested includes at least one media query, and wherein the at least one media query includes at least one of a media-type and feature. One or more contextual properties associated with the second computing device are identified at the first computing device from the one or more request parameters. At least a portion of media query extensions associated with the at least one media query is executed at the first computing device based upon, at least in part, the one or more contextual properties, wherein at least the portion of the media query extensions is executed at the first computing device before a response to the HTTP request is sent to the second computing device. The response to the HTTP request is sent to the second computing device.

One or more of the following features may be included. The one or more contextual properties may include one or more user-agent properties associated with the second computing device. The one or more contextual properties may include one or more connectivity properties associated with the second computing device. The one or more contextual properties may include location information associated with the second computing device. The one or more contextual properties may include run-time properties associated with the second computing device. Non-applicable information may be removed from the response to the HTTP request sent to the second computing device, wherein the non-applicable information may be removed from a cascading style sheet, and wherein the non-applicable information may be identified from the one or more request parameters. The one or more request parameters may include an HTTP request parameter.

In another implementation, a computing system includes a processor and a memory configured to perform operations that may comprise receiving, at a first computing device from a second computing device, an HTTP request, including one or more request parameters, for a CSS file, wherein the CSS file requested includes at least one media query, and wherein the at least one media query includes at least one of a media-type and feature. One or more contextual properties associated with the second computing device are identified at the first computing device from the one or more request parameters. At least a portion of media query extensions associated with the at least one media query is executed at the first computing device based upon, at least in part, the one or more contextual properties, wherein at least the portion of the media query extensions is executed at the first computing device before a response to the HTTP request is sent to the second computing device. The response to the HTTP request is sent to the second computing device.

One or more of the following features may be included. The one or more contextual properties may include one or more user-agent properties associated with the second computing device. The one or more contextual properties may include one or more connectivity properties associated with the second computing device. The one or more contextual properties may include location information associated with the second computing device. The one or more contextual properties may include run-time properties associated with the second computing device. Non-applicable information may be removed from the response to the HTTP request sent to the second computing device, wherein the non-applicable information may be removed from a cascading style sheet, and wherein the non-applicable information may be identified from the one or more request parameters. The one or more request parameters may include an HTTP request parameter.

In another implementation, a computer program product resides on a computer readable storage medium that has a plurality of instructions stored on it. When executed by a processor, the instructions cause the processor to perform operations that may comprise receiving, at a first computing device from a second computing device, an HTTP request, including one or more request parameters, for a CSS file, wherein the CSS file requested includes at least one media query, and wherein the at least one media query includes at least one of a media-type and feature. One or more contextual properties associated with the second computing device are identified at the first computing device from the one or more request parameters. At least a portion of media query extensions associated with the at least one media query is executed at the first computing device based upon, at least in part, the one or more contextual properties, wherein at least the portion of the media query extensions is executed at the first computing device before a response to the HTTP request is sent to the second computing device. The response to the HTTP request is sent to the second computing device.

One or more of the following features may be included. The one or more contextual properties may include one or more user-agent properties associated with the second computing device. The one or more contextual properties may include one or more connectivity properties associated with the second computing device. The one or more contextual properties may include location information associated with the second computing device. The one or more contextual properties may include run-time properties associated with the second computing device. Non-applicable information may be removed from the response to the HTTP request sent to the second computing device, wherein the non-applicable information may be removed from a cascading style sheet, and wherein the non-applicable information may be identified from the one or more request parameters. The one or more request parameters may include an HTTP request parameter.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is an illustrative diagrammatic view of a media query process coupled to a distributed computing network according to one or more implementations of the present disclosure;

FIG. 2 is a diagrammatic view of a client electronic device of FIG. 1 according to one or more implementations of the present disclosure;

FIG. 3 is an illustrative flowchart of the media query process of FIG. 1 according to one or more implementations of the present disclosure;

FIG. 4 is an illustrative diagrammatic view of an HTTP request of FIG. 1 according to one or more implementations of the present disclosure;

FIG. 5 is an illustrative flowchart of the media query process of FIG. 1 according to one or more implementations of the present disclosure; and

FIG. 6 is an illustrative conceptual class diagram according to one or more implementations of the present disclosure.

Like reference symbols in the various drawings indicate like elements.

### DETAILED DESCRIPTION

### System Overview:

As will be appreciated by one skilled in the art, the present disclosure may be embodied as a method, system, or computer program product. Accordingly, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of this document, a computer-usable or computer-readable, storage medium may be any tangible medium that can contain or store a program for use by or in connection with the instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. The computer readable program code may be transmitted using any appropriate medium, including but not limited to the internet, wireline, optical fiber cable, RF, etc. A computer readable signal medium may be any computer readable medium that is not a computer readable storage medium and that can communicate, propagate, or transport a program for use by or in connection with an instruction execution system, apparatus, or device.

Computer program code for carrying out operations of the present disclosure may be written in an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript or PERL. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider).

The flowchart and block diagrams in the figures illustrate the architecture, functionality, and operation of possible implementations of apparatus (systems), methods and computer program products according to various implementations of the present disclosure. It will be understood that each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some alternative implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

The computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

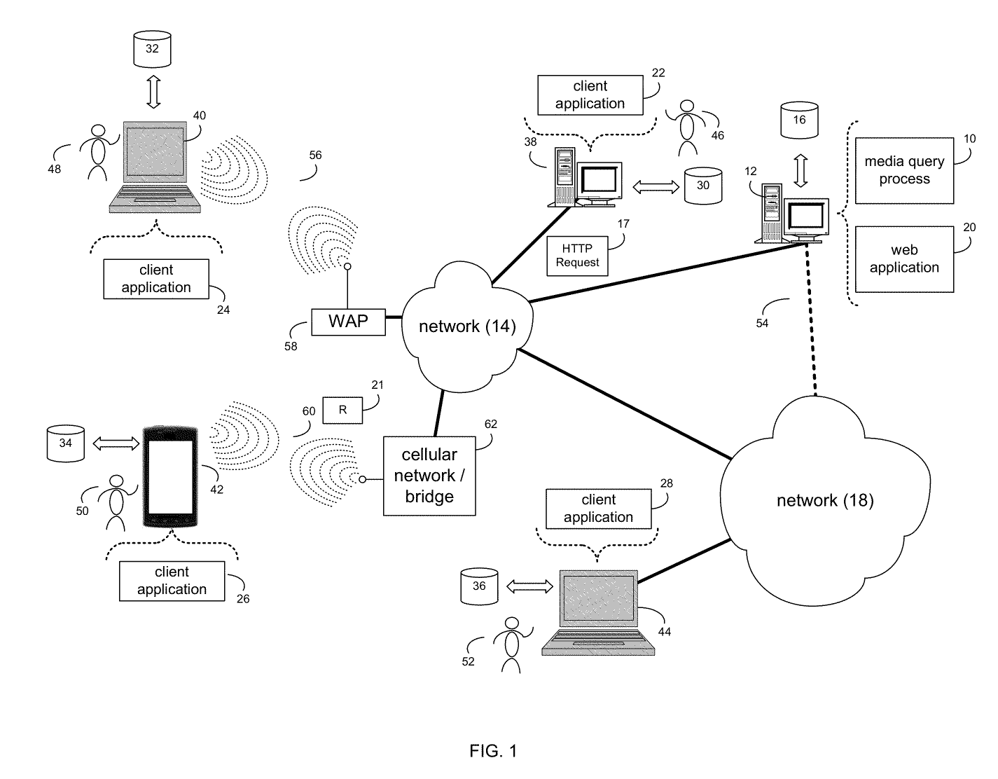

Referring to FIG. 1, there is shown media query process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, media query process 10 may receive, at a first computing device from a second computing device, an HTTP request (e.g., HTTP request 17), including one or more request parameters, for a CSS file, wherein the CSS file requested may include at least one media query, and wherein the at least one media query may include at least one of a media-type and feature. One or more contextual properties associated with the second computing device may be identified at the first computing device from the one or more request parameters. At least a portion of media query extensions associated with the at least one media query may be executed at the first computing device based upon, at least in part, the one or more contextual properties, wherein at least the portion of the media query extensions may be executed at the first computing device before a response to the HTTP request is sent to the second computing device. The response (e.g., response 21) to the HTTP request may be sent to the second computing device.

The instruction sets and subroutines of media query process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Computer 12 may include a data store, such as a database (e.g., relational database, object-oriented database, triplestore database, device description repository, etc.) and may be located within any suitable memory location, such as storage device 16 coupled to computer 12. Any data described throughout the present disclosure may be stored in the data store. In some implementations, computer 12 may utilize a database management system such as, but not limited to, “My Structured Query Language” (MySQL®) in order to provide multi-user access to one or more databases, such as the above noted relational database. The data store may also be a custom database, such as, for example, a flat file database or an XML database. Any other form(s) of a data storage structure and/or organization may also be used. Media query process 10 may be a component of the data store, a stand alone application that interfaces with the above noted data store and/or an applet/application that is accessed via client applications 22, 24, 26, 28. The above noted data store may be, in whole or in part, distributed in a cloud computing topology. In this way, computer 12 and storage device 16 may refer to multiple devices, which may also be distributed throughout the network.

Computer 12 may execute a web application (e.g., web application 20), examples of which may include, but are not limited to, e.g., a web hosting application, a gaming application, a data storage application, enterprise application, or other application that allows for serving content to requesting clients via the Internet using, e.g., Hypertext Transfer Protocol (HTTP) or other appropriate protocol. However, it will be appreciated that web application may also be found embedded in devices (e.g., printers, routers, webcams, etc.) and may only serve a local network. Media query process 10 and/or web application 20 may be accessed via client applications 22, 24, 26, 28. Media query process 10 may be a stand alone application, or may be an applet/application/script that may interact with and/or be executed within web application 20 and/or one or more of client applications 22, 24, 26, 28. Web application 20 may be a stand alone application, or may be an applet/application/script that may interact with and/or be executed within media query process 10 and/or one or more of client applications 22, 24, 26, 28. One or more of client applications 22, 24, 26, 28 may be a stand alone application, or may be an applet/application/script that may interact with and/or be executed within media query process 10 and/or web application 20. Examples of client applications 22, 24, 26, 28 may include, but are not limited to, e.g., a web hosting application, a gaming application, a data storage application, enterprise application, or other application that allows for serving content to requesting clients via the Internet using, e.g., Hypertext Transfer Protocol (HTTP) or other appropriate protocol. However, it will be appreciated that web application may also be found embedded in devices (e.g., printers, routers, webcams, etc.) and may only serve a local network, a standard and/or mobile web browser, user-agent, an email client application, a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36 coupled to client electronic devices 38, 40, 42, 44, may be executed by one or more processors (not shown) and one or more memory architectures (not shown) incorporated into client electronic devices 38, 40, 42, 44.

Storage devices 30, 32, 34, 36 may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Android™, Apple® iOS®, Mac® OS X®; Red Hat® Linux®, or a custom operating system.

One or more of client applications 22, 24, 26, 28 may be configured to effectuate some or all of the functionality of media query process 10 (and vice versa). Accordingly, media query process 10 may be a purely server-side application, a purely client-side application, or a hybrid server-side/client-side application that is cooperatively executed by one or more of client applications 22, 24, 26, 28 and/or media query process 10.

One or more of client applications 22, 24, 26, 28 may be configured to effectuate some or all of the functionality of web application 20 (and vice versa). Accordingly, web application 20 may be a purely server-side application, a purely client-side application, or a hybrid server-side/client-side application that is cooperatively executed by one or more of client applications 22, 24, 26, 28 and/or web application 20. As one or more of client applications 22, 24, 26, 28, media query process 10, and web application 20, taken singly or in any combination, may effectuate some or all of the same functionality, any description of effectuating such functionality via one or more of client applications 22, 24, 26, 28, media query process 10, web application 20, or combination thereof, and any described interaction(s) between one or more of client applications 22, 24, 26, 28, media query process 10, web application 20, or combination thereof to effectuate such functionality, should be taken as an example only and not to limit the scope of the disclosure.

Users 46, 48, 50, 52 may access computer 12 and media query process 10 (e.g., using one or more of client electronic devices 38, 40, 42, 44) directly through network 14 or through secondary network 18. Further, computer 12 may be connected to network 14 through secondary network 18, as illustrated with phantom link line 54. Media query process 10 may include one or more user interfaces, such as browsers and textual or graphical user interfaces, through which users 46, 48, 50, 52 may access media query process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, and/or Bluetooth™ device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

Some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

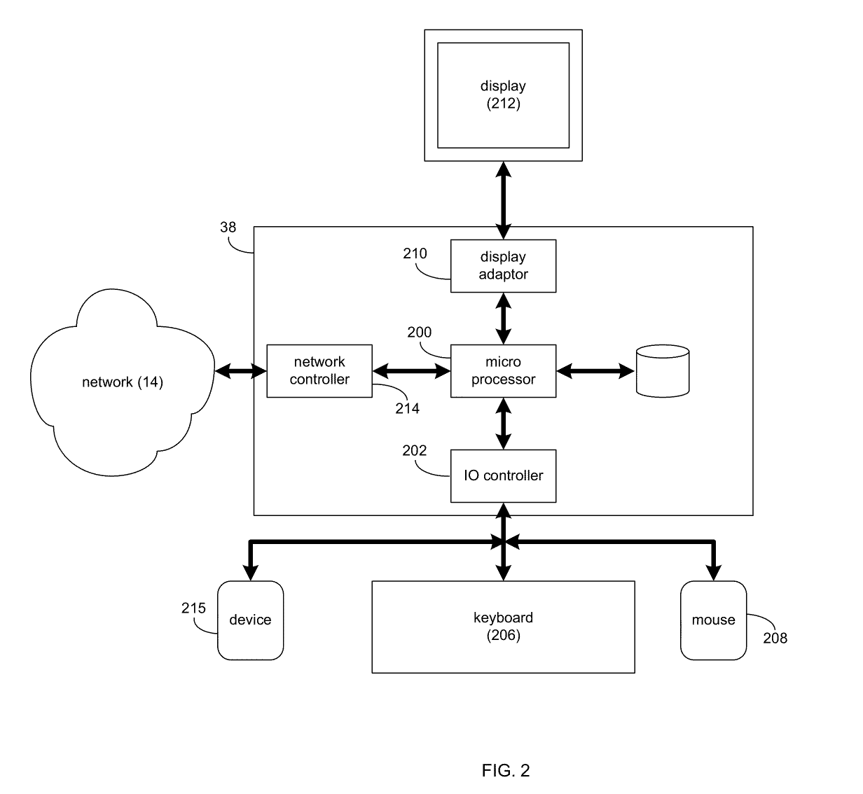

Referring also to FIG. 2, there is shown a diagrammatic view of client electronic device 38. While client electronic device 38 is shown in this figure, this is for illustrative purposes only and is not intended to be a limitation of this disclosure, as other configurations are possible. For example, any computing device capable of executing, in whole or in part, media query process 10 may be substituted for client electronic device 38 within FIG. 2, examples of which may include but are not limited to computer 12 and/or client electronic devices 40, 42, 44.

Client electronic device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device. An I/O controller (e.g., I/0 controller 202) may be configured to couple microprocessor 200 with various devices, such as keyboard 206, pointing/selecting device (e.g., mouse 208), custom device (e.g., device 215), USB ports (not shown), and printer ports (not shown). A display adaptor (e.g., display adaptor 210) may be configured to couple display 212 (e.g., CRT or LCD monitor(s)) with microprocessor 200, while network controller/adaptor 214 (e.g., an Ethernet adaptor) may be configured to couple microprocessor 200 to the above-noted network 14 (e.g., the Internet or a local area network).

The Media Query Process:

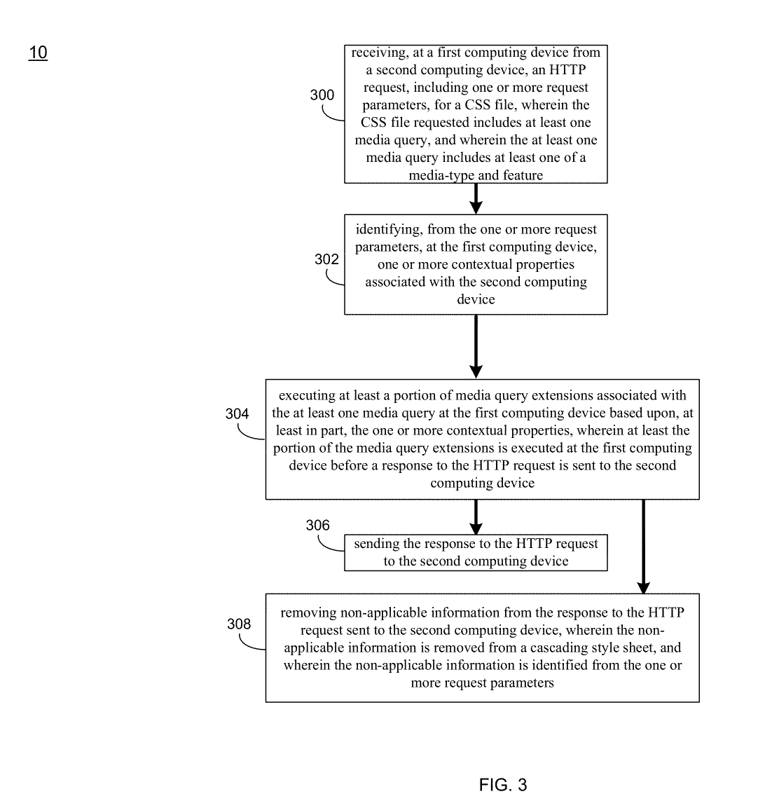

As discussed above and referring also to FIGS. 3-6, media query process 10 may receive 300, at a first computing device from a second computing device, an HTTP request, including one or more request parameters, for a CSS file, wherein the CSS file requested may include at least one media query, and wherein the at least one media query may include at least one of a media-type and feature. One or more contextual properties associated with the second computing device may be identified 302 by media query process 10 at the first computing device from the one or more request parameters. At least a portion of media query extensions associated with the at least one media query may be executed 304 by media query process 10 at the first computing device based upon, at least in part, the one or more contextual properties, wherein at least the portion of the media query extensions may be executed at the first computing device before a response to the HTTP request is sent to the second computing device. The response to the HTTP request may be sent 306 to the second computing device by media query process 10.

In some implementations, media query process 10 may include a service that may allow for, e.g., custom media features when creating such things as media queries. Media queries may include such things as, e.g., media types and features. This may enable web-developers to, e.g., create more responsive and engaging web pages for a broader range of devices, while still keeping stylesheets limited in size. In some implementations, the present disclosure may help reduce the size of downloaded data when responding to a media query request. As will be discussed in greater detail, media query process 10 may introduce a number of custom media features based on, e.g., user-agent capabilities/properties present in a device database (e.g., WURFL), while still utilizing the standard Media Query syntax. As will also be discussed in greater detail, media query process 10 may also enable for querying, e.g., network properties, such as bandwidth, carrier, connectivity/network properties/type, etc., location information, and run-time properties. Notably, the present disclosure does not discuss media queries in general, or the example syntax used by media query process 10 (e.g., which may include a parser), as they are well known to those skilled in the art. It will be appreciated that while one or more implementations may be described based upon the user of a particular example syntax, other syntax may be used without departing from the scope of the disclosure.

In some implementations, media query process 10 may receive 300, at a first computing device (e.g., computer 12) from a second computing device (e.g., client electronic device 42), an HTTP request (e.g., HTTP request 17) for a CSS file. For instance, assume for example purposes only that a user (e.g., user 50) would like to access, e.g., a web page via a web browser application of client application 26. In the example, user 50 may (e.g., via client electronic device 42, client application 26, media query process 10, web application 20, or combination thereof) send a request (e.g., HTTP request 17) to access the web page, which may be received 300 by a web server (e.g., computer 12) via web application 20 hosting the web page. A non-limiting example of a “standard” media query, which may be included with HTTP request 17, and may be executed by the browser of client application 26, may look like this:

@media only screen and (min-device-width : 768px) and
(max-device-width : 1024px){
/*styles matching the media query*/
}

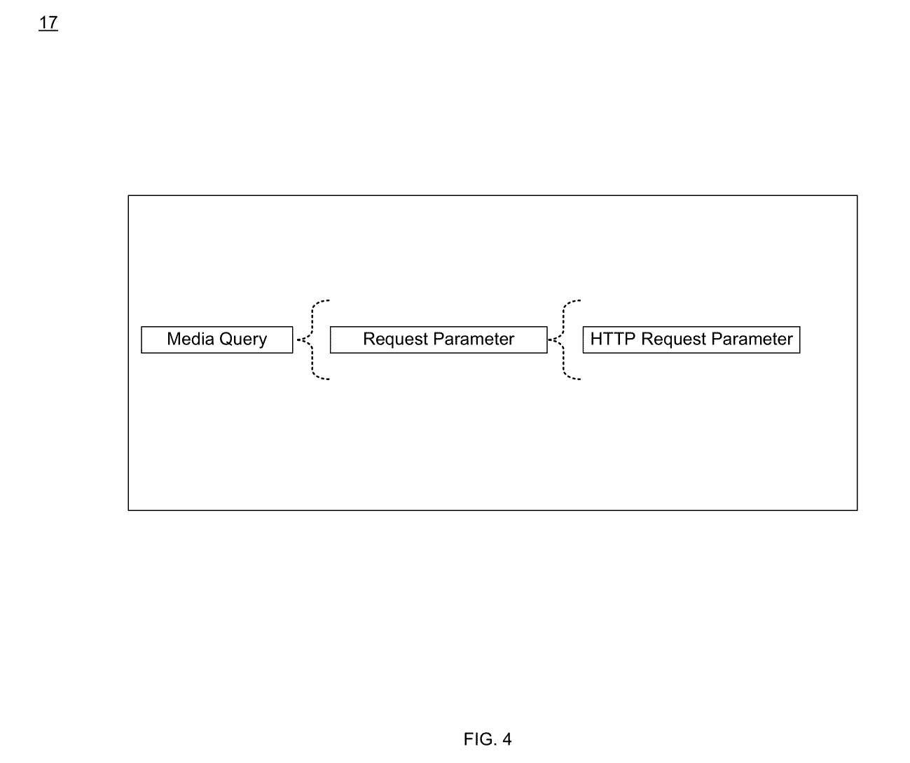

In some implementations, and referring at least to FIG. 4, HTTP request 17 for the CSS file may include one or more request parameters, wherein the CSS file requested may include at least one media query that may include at least one of a media-type and feature, and the one or more request parameters may include an HTTP request parameter. An example of an HTTP request parameter (e.g., an HTTP header parameter) may include but is not limited to a user-agent string, which may identify the user-agent. Media query process 10 and/or client application 26 may include the user-agent, which may be broadly described as the client software originating the HTTP request, such as a device or browser. There are a number of other HTTP header parameters that may be used, both standard HTTP parameters, such as “Accept” which may identify content types/mime types accepted by the user-agent, vendor specific parameters such as “X-OperaMini-Phone-UA” which may identify the original user-agent string, and other non-standard parameters typically prefixed with “x-” that may identify anything from gateways, carriers, connectivity and other features/capabilities of the device or network. As such, the description of an HTTP request parameter including a user-agent string should be taken as an example only and not to otherwise limit the scope of the disclosure.

Media query process 10 may analyze the received 300 HTTP request 17 for CSS stylesheet. For example, in some implementations, one or more contextual properties associated with client electronic device 42 may be identified 302 by media query process 10 at computer 12 from the one or more request parameters. The contextual capabilities may be accessible, identified 302, and/or looked up (e.g., via media query process 10 and/or web application 20) through the media query syntax. In some implementations, the WURFL device repository may be accessed by media query process 10 to identify 302 contextual properties, as it contain more reliable data than the browser might respond to, with regards to, e.g., false positives and poor standards implementation by browser vendors.

Media query process 10 may be enabled to handle one or more contextual properties (e.g., dimensions) that taken singly or in any combination may define the user experience when accessing the web page, which may provide useful media features. For instance, in some implementations, the one or more contextual properties may include one or more user-agent properties associated with client electronic device 42. In the example, this may include properties of client electronic device 42 and/or client application 26 retrieved from the above-noted WURFL device repository, and custom additions may be used in media feature lookups by media query process 10. The WURFL device repository may contain more than 500 capabilities for each device. Examples may include but are not limited to operating system and version, brand, model (e.g., to display correct ads relevant to the operating system, version, brand, and model), screen size (e.g., to resize images and font size to be readable on screen, reorganize layout to better present the message to the user, etc.), support for various content types, interaction method (e.g., mouse, keyboard, stylus, touch screen), radio and connectivity features, hardware related capabilities such as NFC support, memory and processor speed. This information may be useful, e.g., to ensure maximum accessibility and ensure that content and experience is available for as many computing devices as possible.

In some implementations, the one or more contextual properties may include one or more connectivity properties associated with client electronic device 42. For example, connectivity properties may include but are not limited to network information, such as uplink speed, network type, operator/carrier, network latency, download speed, location data, etc. The contextual properties may be used to help deliver different user experiences. For instance, for network speed, if client electronic device 42 were on a slower network, less content may be returned, content may be compressed more, etc., to let client electronic device 42 display the content quicker. As another example, for the network type, mobile networks may have a much higher latency and therefore it may be desirable to limit the number of HTTP requests to speed up rendering time. This may be done by, e.g., inlining content or removing unimportant content or other known strategies.

In some implementations, the one or more contextual properties may include location information associated with client electronic device 42. For example, location information may include but is not limited to country, city, coordinates, etc. The location information may be determined by media query process 10 using, e.g., Global Positioning Systems (GPS) associated with client electronic device 42, IP address, Operator, or by other known techniques. Location information may be used as another example of how to help deliver different user experiences. For instance, location information may be used to display different languages (e.g., if the GPS determines that client electronic device 42 is in China, the content may be returned in Chinese), display different ads, and display/focus on different content.

In some implementations, the one or more contextual properties may include run-time properties associated with client electronic device 42. For example, run-time properties may include but are not limited to browser and/or runtime information that may be used to verify which device properties may be accessed through the actual browser and/or runtime. Additional examples of browser and/or runtime information may include, e.g., height and width of browser window, device pixel ratio of the current physical display, etc. Further, the device properties may differ from the browser and/or runtime information (e.g., properties) as one device may have multiple runtimes that may consume web content. Examples include but are not limited to smart phone applications with a built in “web view” or other types of “widgets” based on web technology. Browser and/or runtime properties may include, e.g., level of HTML support, special limitations due to runtime restrictions, or other runtime specific enhancements allowing more advanced functionality to be used. Browser and/or runtime information may be used as another example of how to help deliver different user experiences. For instance, browser and/or runtime information may be used to resize images according to actual display size of the browser, or deliver high-res images if the display is a retina screen, etc.

In some implementations, media query process 10 (e.g., via web application 20) may render the source CSS, containing media query extensions, on computer 12 based upon (at least in part) one or more of the above-noted contextual properties. For example, in some implementations, at least a portion of media query extensions associated with the at least one media query may be executed 304 by media query process 10 at computer 12 based upon, at least in part, the one or more contextual properties, wherein at least the portion of the media query extensions may be executed at computer 12 before a response to HTTP request 17 is sent to client electronic device 42. In some implementations, by executing media query extensions on the server (e.g., computer 12), the relevant styles may be sent to the browser when responding to the HTTP request, while irrelevant styles need not be sent to the browser when responding to the HTTP request.

For example, an HTTP request including a media query with extensions based upon contextual properties of device/browser capabilities executed by media query process 10 and/or web application 20 at computer 12 may look like this:

@media handheld and (-mt-pointing_method: touchscreen) {
/*styles handheld devices with touch screen here*/
}

In some implementations, the above example may only be rendered to handheld devices with a touch screen.

In some implementations, the below example may display styles for devices running Android version 2.3 as the contextual property:

@media all and (-mt-device_os: Android) and
(-mt-device_os_version: 2.3) {
/*styles for devices running Android version 2.3 here*/
}

Below is an example of media queries using network properties as the contextual property:

@media all and (-mt-network_type: 3G) and
(-mt-mobile_network_code: 310_150) {
/*styles for AT&T customers connected on 3G here*/
}

The World Wide Web Consortium (W3C) may be able to access device sensors, etc. Media query process 10 may utilize the extended CSS media queries executed server side to add value by using the standard media query syntax to access even more media features server-side. An example difference may be the way these media features may be accessed. For example, the standard media queries may be executed by media query process 10 and/or the browser of client application 26, while the extended CSS media queries may be executed server side by media query process 10 and/or web application 20 before the response is sent 306 back to the browser.

Media query process 10 may remove 308 non-applicable information from the response (e.g., response 21) to HTTP request 17 sent 306 to client electronic device 42, wherein the non-applicable information may be removed 308 from a cascading style sheet (CSS), and wherein the non-applicable information may be identified from the one or more request parameters. As a result, media query process 10 may generate an optimized CSS. For example, if client electronic device 42 has a screen size less than 768 pixels wide, and is requesting a cascading style sheet which contains the below media query, the styles enclosed by the media query, and the query itself, may be removed from the response to client electronic device 42 since the condition in the query may not be true for that particular device due to its physical screen size. This operation may reduce the payload transferred to the device.

@media only screen and (min-device-width : 768px) and
(max-device-width : 1024px){
/*styles for devices matching the media query*/
}

The response (e.g., response 21) to HTTP request 17 may be sent 306 to client electronic device 42 by media query process 10. For example, the optimized CSS generated by media query process 10 may be sent 306 to the browser/user-agent associated with client application 26. Media query process 10 may (e.g., via client application 26) render the requested web page on a display of client electronic device 42 according to the optimized CSS. For instance, continuing with the above example, media query process 10 may remove images inlined in CSS. The CSS rendered to the browser may also potentially hide elements using, e.g., “visibility: hidden;”. As the CSS may be used to set the relative positioning of some or all elements within a web page, elements may be shuffled around if, e.g., the style that overrides a style is removed. For example, CSS may be like this:

```
.generic {
    /* generic style setting a basic layout as fallback */
}
@media all and (-mt-device_os: Anroid) {
  .advanced {
    /* advanced style overriding the generic style */
  }
}
```

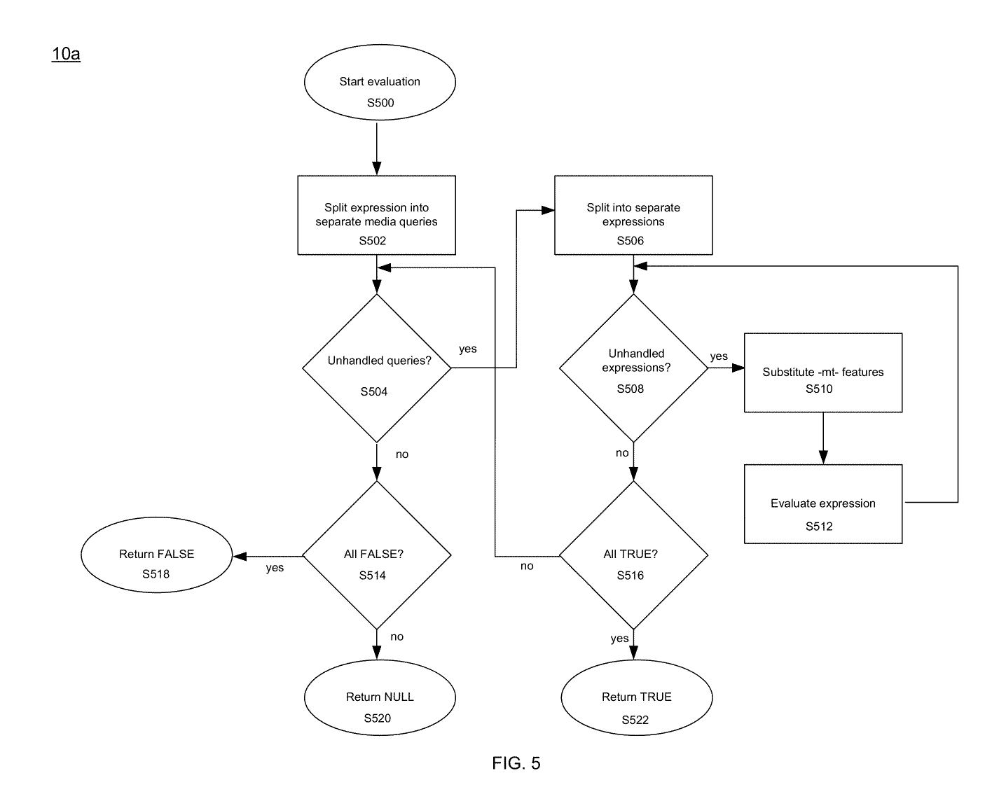

For example, in some implementations, and referring at least to FIG. 5, media query process 10 may include an “extended” media query engine 10a, which may allow for any number of media features not found in the above-noted W3C recommendation, as long as, e.g., the property is prefixed, in this example by -mt-. The input for extended media query engine 10a may include a single media query, such as the media query included in HTTP request 17. As used herein, media query process 10 and media query engine 10a may be used interchangeably.

After receiving 300 the HTTP request, a download of the CSS file may be initiated by media process 10 and/or web application 20, where parsing may begin. In the example, for each media query block found, the following flow may be executed by media query process 10 (in no particular order):

S500. The media query block may be sent to extended media query engine 10a to start the evaluation.

S502. If the media query contains multiple expressions, media query process 10 may split it into a list of expressions which may be passed as input to S504.

S504. For each item in the list, media query process 10 may check whether it is needed to evaluate another item. If there are more items in the “to do-list” media query process 10 may enter S506. If all conditions are evaluated, media query process 10 may enter S514.

S506. As each media query expression from S502 may still consist of multiple conditions, media query process 10 may make a new list of expressions having only one condition. The list may be input to S508.

S508. If the list from S508 still contains unevaluated expressions, media query process 10 may enter S510.

S510. Media query process 10 may substitute the extended media capability keywords with their real value based on the above-noted device library data.

S512. Media query process 10 may evaluate the media query expression.

S514. If all media query expressions have been evaluated, media query process 10 may return false at S518 and the CSS inside this media query block may not be rendered into the resulting CSS file. If some media query expressions have not been evaluated, media query process 10 may return NULL at S520, e.g., resulting in the non-evaluated media query expression(s) block being rendered into the CSS and passed to the web-browser for evaluation).

S516. If all media queries have been evaluated to true, media query process 10 may enter S522, and the CSS in the media query block may be rendered to the resulting CSS file.

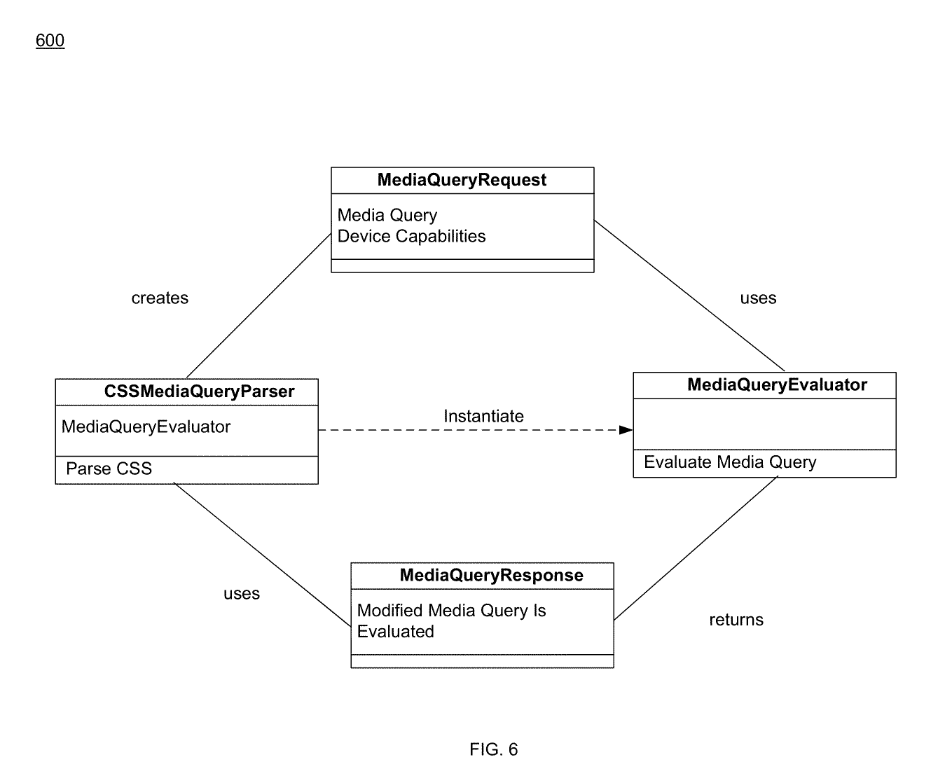

Referring also at least to FIG. 6 in conjunction with FIG. 5, a conceptual class diagram 600 associated with media query process 10 is shown. In some implementations, media query process 10 and/or web application 20 may include a CSSMediaQueryParser, which may parse the CSS, e.g., sequentially. The CSSMediaQueryParser may divide any media query list into single media queries, which may then be input to a MediaQueryEvaluator. The CSSMediaQueryParser may merge all the results for the whole list into a true or false statement as described above. This result may be used to identify whether the styles encapsulated by the media query should be rendered to client electronic device 42. If the response contains a modified media query, this may be evaluated by the browser on client electronic device 42.

Conceptual class diagram 600 may show that a server-side parsing of media queries (with extension) may have been implemented as a service that may be extended to different applications. This service may take media queries as input and returns a result (true/false/unevaluated expressions). The code that uses this service may then, based on the result returned, take an action. In some implementations, various example applications that may be used as noted above may include but are not limited to: a CSS proxy associated with media query process 10 doing server-side media query evaluation of CSS; an HTML proxy associated with media query process 10 doing server-side media query evaluation for deciding whether to include a javascript or not; and an HTML proxy associated with media query process 10 doing server-side media query evaluation for deciding whether to include a CSS file or not.

In some implementations, extending media queries with, e.g., WURFL based media features server side, may enable less data to be download for the browser, since, e.g., the CSS is more specific and relevant to that specific device/browser. In some implementations, extending media queries may enable it to be cheaper for the end user, since, e.g., less data transfer may also result in it being cheaper for the end user when connected on, e.g., telco networks. In some implementations, extending media queries may enable faster page rendering, since, e.g., there is less data downloaded, which also means less style rules to evaluate, which leads to faster page rendering. In some implementations, extending media queries may enable reduced battery consumption, since, e.g., heavy use of media queries and “css hacks” may drain battery power. Specific style information may address this issue. In some implementations, extending media queries may enable better handling of “false positives”, since, e.g., even if the user-agent claims support for a given feature, media query process 10 may override it server side.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, and combinations thereof) are possible without departing from the scope of the disclosure defined in the appended claims.

What is claimed is:

1. A computer-implemented method comprising:
receiving, at a first computing device from a second computing device, an HTTP request for a CSS file, including one or more request parameters, wherein the CSS file requested includes at least one media query, and wherein the at least one media query includes at least one of a media-type and feature;
identifying, from the one or more request parameters, at the first computing device, one or more contextual properties associated with the second computing device;
executing at least a portion of media query extensions associated with the at least one media query at the first computing device based upon, at least in part, the one or more contextual properties, wherein at least the portion of the media query extensions is executed at the first computing device before a response to the HTTP request is sent to the second computing device; and
sending the response to the HTTP request to the second computing device.

2. The computer-implemented method of claim 1 wherein the one or more contextual properties include one or more user-agent properties associated with the second computing device.

3. The computer-implemented method of claim 1 wherein the one or more contextual properties include one or more connectivity properties associated with the second computing device.

4. The computer-implemented method of claim 1 wherein the one or more contextual properties include location information associated with the second computing device.

5. The computer-implemented method of claim 1 wherein the one or more contextual properties include run-time properties associated with the second computing device.

6. The computer-implemented method of claim 1 further comprising removing non-applicable information from the response to the HTTP request sent to the second computing device, wherein the non-applicable information is removed from a cascading style sheet, and wherein the non-applicable information is identified from the one or more request parameters.

7. The computer-implemented method of claim 1 wherein the one or more request parameters includes an HTTP request parameter.

8. A computer program product residing on a computer readable storage medium having a plurality of instructions stored thereon which, when executed by a processor, cause the processor to perform operations comprising:
receiving, at a first computing device from a second computing device, an HTTP request for a CSS file, including one or more request parameters, wherein the CSS file requested includes at least one media query, and wherein the at least one media query includes at least one of a media-type and feature;
identifying, from the one or more request parameters, at the first computing device, one or more contextual properties associated with the second computing device;
executing at least a portion of media query extensions associated with the at least one media query at the first computing device based upon, at least in part, the one or more contextual properties, wherein at least the portion of the media query extensions is executed at the first computing device before a response to the HTTP request is sent to the second computing device; and
sending the response to the HTTP request to the second computing device.

9. The computer program product of claim 8 wherein the one or more contextual properties include one or more user-agent properties associated with the second computing device.

10. The computer program product of claim 8 wherein the one or more contextual properties include one or more connectivity properties associated with the second computing device.

11. The computer program product of claim 8 wherein the one or more contextual properties include location information associated with the second computing device.

12. The computer program product of claim 8 wherein the one or more contextual properties include run-time properties associated with the second computing device.

13. The computer program product of claim 8 further comprising removing non-applicable information from the response to the HTTP request sent to the second computing device, wherein the non-applicable information is removed from a cascading style sheet, and wherein the non-applicable information is identified from the one or more request parameters.

14. The computer program product of claim 8 wherein the one or more request parameters includes an HTTP request parameter.

15. A computing system including a processor and a memory configured to perform operations comprising:
receiving, at a first computing device from a second computing device, an HTTP request for a CSS file, including one or more request parameters, wherein the CSS file requested includes at least one media query, and wherein the at least one media query includes at least one of a media-type and feature;
identifying, from the one or more request parameters, at the first computing device, one or more contextual properties associated with the second computing device;
executing at least a portion of media query extensions associated with the at least one media query at the first computing device based upon, at least in part, the one or more contextual properties, wherein at least the portion of the media query extensions is executed at the first computing device before a response to the HTTP request is sent to the second computing device; and
sending the response to the HTTP request to the second computing device.

16. The computing system of claim 15 wherein the one or more contextual properties include one or more user-agent properties associated with the second computing device.

17. The computing system of claim 15 wherein the one or more contextual properties include one or more connectivity properties associated with the second computing device.

18. The computing system of claim 15 wherein the one or more contextual properties include location information associated with the second computing device.

19. The computing system of claim 15 wherein the one or more contextual properties include run-time properties associated with the second computing device.

20. The computing system of claim 15 further comprising removing non-applicable information from the response to the HTTP request sent to the second computing device, wherein the non-applicable information is removed from a cascading style sheet, and wherein the non-applicable information is identified from the one or more request parameters.

21. The computing system of claim 15 wherein the one or more request parameters includes an HTTP request parameter.
